(19) United States
(12) Patent Application Publication
(10) Pub. No.: US 2026/0360310 A1
(43) Pub. Date: Nov. 12, 2026

(54) PIXEL CIRCUIT FOR CONTROLLING LIGHT-EMITTING ELEMENT

(71) Applicant: Shanghai AVIC Optoelectronics Co., Ltd., Shanghai (CN)

(72) Inventors: Genshiro Kawachi, Kawasaki (JP); Masamichi Shimoda, Kawasaki (JP); Jiro Yanase, Kawasaki (JP)

(73) Assignee: Shanghai AVIC Optoelectronics Co., Ltd., Shanghai (CN)

(21) Appl. No.: 19/665,289

(22) Filed: May 1, 2026

(30) Foreign Application Priority Data
May 9, 2025 (JP) 2025-078585

(51) Int. Cl. G09G 3/3233; G09G 3/32

(52) U.S. Cl. CPC G09G 3/3233; G09G 3/32; G09G 2300/0842; G09G 2310/0245; G09G 2320/0247; G09G 2330/021

(57) ABSTRACT

A pixel circuit includes a light-emitting element, a driving transistor configured to control electric current to be supplied to the light-emitting element, a storage capacitor connected to a gate node of the driving transistor, a first switching transistor and a second switching transistor connected in series between the gate node of the driving transistor and a constant potential supply line, a first capacitor connected between a constant-potential node and an intermediate node between the first switching transistor and the second switching transistor, and a second capacitor connected between the intermediate node and a gate node of the first switching transistor.

### CROSS-REFERENCE TO RELATED APPLICATIONS

This non-provisional application claims priority under 35 U.S.C. §119(a) on Patent Application No. 2025-078585 filed in Japan on May 9, 2025, the entire content of which is hereby incorporated by reference.

### BACKGROUND

This disclosure relates to a pixel circuit for controlling a light-emitting element.

Organic light-emitting diode (OLED) elements and micro-LEDs are current-driven light-emitting elements and therefore, they have advantages such as no need of backlight and achievement of low power consumption, wide viewing angle, and high contrast ratio; they are expected to contribute to development of flat panel display devices.

An active-matrix type of display device includes transistors for selecting pixels and driving transistors for supplying electric current to the pixels. The transistors in the display device are thin-film transistors (TFTs) and commonly, they can be low-temperature polysilicon (LTPS) TFTs or oxide semiconductor TFTs.

### SUMMARY

A pixel circuit according to an aspect of this disclosure includes a light-emitting element, a driving transistor configured to control electric current to be supplied to the light-emitting element, a storage capacitor connected to a gate node of the driving transistor, a first switching transistor and a second switching transistor connected in series between the gate node of the driving transistor and a constant potential supply line, a first capacitor connected between a constant-potential node and an intermediate node between the first switching transistor and the second switching transistor, and a second capacitor connected between the intermediate node and a gate node of the first switching transistor.

It is to be understood that both the foregoing general description and the following detailed description are exemplary and explanatory and are not restrictive of this disclosure.

### BRIEF DESCRIPTION OF THE DRAWINGS

FIG. 1 schematically illustrates a configuration example of an OLED display device, which is a display device related to an embodiment of this disclosure.

FIG. 2 illustrates a configuration example of a pixel circuit in an embodiment.

FIG. 3 is a timing chart of the signals for controlling the pixel circuit illustrated in FIG. 2 in one frame period.

FIG. 4A illustrates the state of a pixel circuit in the period of data write (T6 – T7).

FIG. 4B illustrates the state of the pixel circuit in the period immediately after the data write (T7 – T8).

FIG. 4C illustrates the state of the pixel circuit in the initial period of light emission (T8 – T10).

FIG. 4D illustrates the state of the pixel circuit in the latter period of light emission (T10 –).

FIG. 5 is a diagram for illustrating the effect of a capacitor to make the feedthrough voltages (ΔV) of a transistor asymmetric.

FIG. 6 provides simulation results on the temporal variation in node potentials in pixel circuits each including a capacitor having a different capacitance when being driven at a normal frame rate of 120Hz and a low frame rate of 1 Hz.

FIG. 7 provides simulation results on the temporal variation in lighting current for the light-emitting element in pixel circuits each including a capacitor having a different capacitance when being driven at a normal frame rate of 120Hz and a low frame rate of 1 Hz.

FIG. 8 provides simulation results on the relation between data refresh rate and a flicker in a pixel circuit.

FIG. 9 illustrates a pixel circuit in which an end of a capacitor is connected to the shield electrode of the driving transistor.

FIG. 10 is a plan diagram schematically illustrating an example of the device structure of a pixel circuit viewed along the layering direction.

FIG. 11 schematically illustrates the cross-sectional structure along the section line A-A’ in FIG. 10.

FIG. 12 is a plan diagram schematically illustrating another example of the device structure of a pixel circuit viewed along the layering direction.

FIG. 13 is a plan diagram schematically illustrating still another example of the device structure of a pixel circuit viewed along the layering direction.

FIG. 14 schematically illustrates the cross-sectional structure along the section line B-B’ in FIG. 13.

FIG. 15 schematically illustrates the cross-sectional structure along the section line C-C’ in FIG. 13.

FIG. 16 illustrates an example of the relation between transmission lines for driving control signals and scanning circuits.

### EMBODIMENTS

Hereinafter, embodiments will be described specifically with reference to the drawings. Elements common to the drawings are denoted by the same reference signs. For clear understanding of the description, some elements in the drawings may be exaggerated in size or shape.

The following discloses a technique to reduce the leakage current from a storage capacitor in a pixel circuit of an electroluminescence display device employing a light-emitting element that lights in response to a driving current, such as an organic light-emitting diode (OLED) display device or a micro-LED display device.

A pixel circuit is demanded to reduce variation in the data voltage stored in a storage capacitor that is caused by leakage current. Especially under a low frame rate driving (low data refresh rate driving) for saving power consumption, the pixel circuit needs to keep a data voltage for a long time; it is important to reduce the leakage current through the switching thin-film transistors (TFTs) in the pixel circuit. In the case where LTPS TFTs are employed for the switching TFTs, the leakage current may become too high to keep the data voltage; the brightness of the light may vary in the cycle of frame rate to be recognized as flickers.

An embodiment of this disclosure describes a pixel circuit that can reduce the leakage current from the switching TFTs and the variation in data voltage caused thereby. The pixel circuit in an embodiment of this disclosure can reduce the variation in data voltage caused by leakage current from the switching TFTs.

### Configuration of Display Device

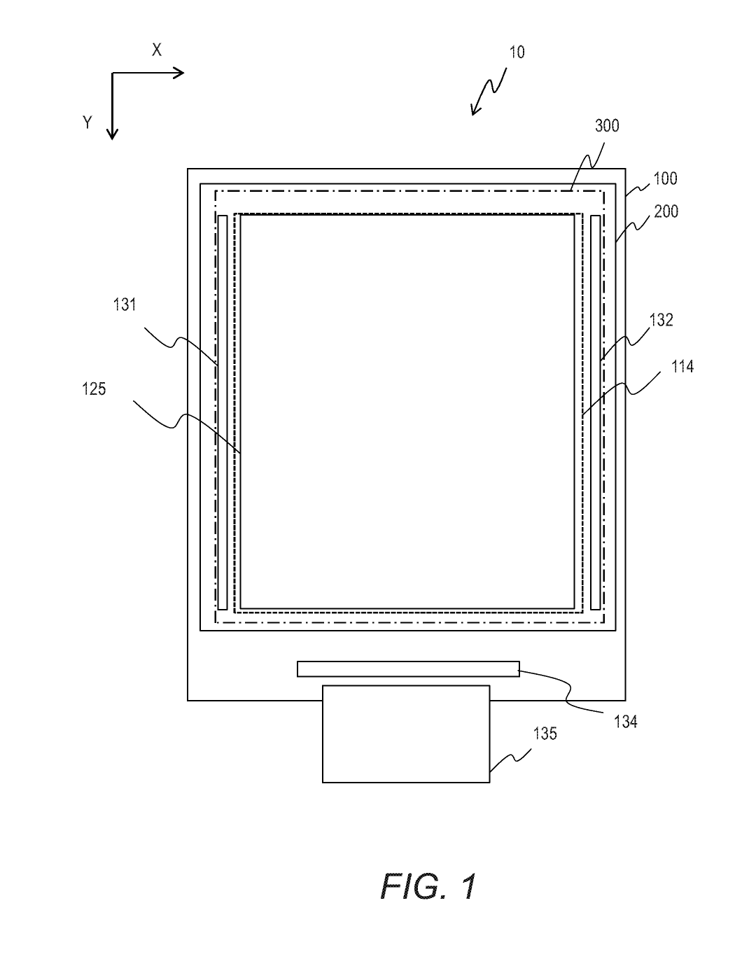

FIG. 1 schematically illustrates a configuration example of an OLED display device 10, which is a display device related to an embodiment of this disclosure. Note that the features of this disclosure are applicable to display devices employing light-emitting elements different from OLEDs, such as micro-LEDs.

The OLED display device 10 includes a thin-film transistor (TFT) substrate 100 on which OLED elements (organic light-emitting elements) are fabricated, an encapsulation substrate 200 for encapsulating the OLED elements, and a bonding member 300 for bonding the TFT substrate 100 with the encapsulation substrate 200. The space between the TFT substrate 100 and the encapsulation substrate 200 is filled with an inactive gas such as dry nitrogen and sealed up with the bonding member 300. In place of the encapsulation substrate 200, a structural encapsulation unit having a different structure, such as a structural encapsulation unit utilizing thin-film encapsulation, can be employed.

In the periphery of a cathode electrode region 114 outer than the display region 125 of the TFT substrate 100, scanning circuits 131 and 132, and a driver IC 134 are provided. The driver IC 134 is connected to the external devices via flexible printed circuits (FPC) 135. The scanning circuits 131 and 132 drive scanning lines on the TFT substrate 100.

The driver IC 134 is mounted with an anisotropic conductive film (ACF), for example. The driver IC 134 provides power and timing signals (control signals) to the scanning circuits 131 and 132 and further, provides a data signal to the display region 125.

The display region 125 includes a plurality of OLED elements (pixels) and a plurality of pixel circuits for controlling light emission of the plurality of pixels. In an example of a color OLED display device, each OLED element emits light in one of the colors of red, blue, and green. The plurality of pixel circuits constitute a pixel circuit array.

As will be described later, each pixel circuit includes a driving TFT (driving transistor) and a storage capacitor for storing a data voltage to determine the driving current of the driving TFT. The data signal transmitted by a data line is adjusted and stored to the storage capacitor. The voltage of the storage capacitor determines the gate voltage (Vgs) of the driving TFT. The adjusted data signal changes the conductance of the driving TFT in an analog manner to supply a forward bias current corresponding to the gray level to the OLED element.

### Pixel Circuit

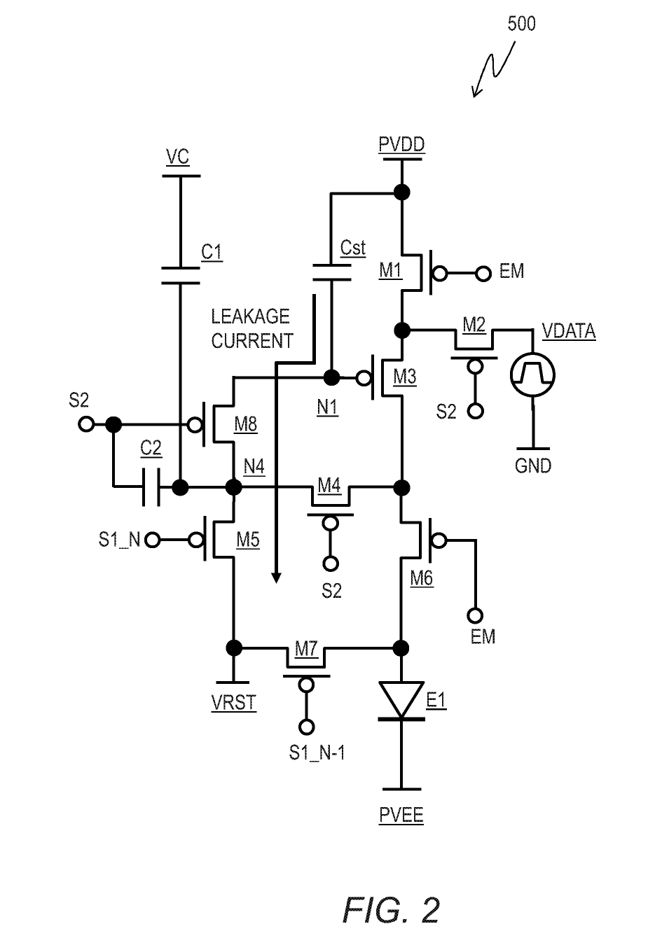

FIG. 2 illustrates a configuration example 500 of a pixel circuit in this embodiment. In the configuration example described in the following, the TFTs included in the pixel circuit 500 are p-type polysilicon TFTs. Assume that the pixel circuit 500 is included in the N-th pixel circuit row. The pixel circuit 500 writes a data signal supplied from the driver IC 134 to a storage capacitor and controls the light emission of the OLED element with the data signal. In the pixel circuit having the features of this disclosure, employment of oxide semiconductor TFTs or n-type TFTs are not excluded.

The pixel circuit 500 includes eight transistors (TFTs) M1 to M8 each having a gate, a source, and a drain. The transistors M1 to M8 in this example are p-type TFTs.

The transistor M3 is a driving transistor for controlling the amount of electric current to the OLED element E1. The driving transistor M3 controls the amount of current to be supplied from an anode power line PVDD to the OLED element E1 in accordance with the voltage stored in the storage capacitor Cst. The cathode of the OLED element E1 is connected to a cathode power line PVEE. The storage capacitor Cst holds the gate-source voltage (also simply referred to as gate voltage) of the driving transistor M3.

The transistors M1 and M6 control whether to light the OLED element E1. The transistor M1 is connected to the anode power line PVDD from its source to switch ON/OFF the supply of the current to the driving transistor M3 connected from its drain. The transistor M6 is connected to the drain of the driving transistor M3 from its source to switch ON/OFF the supply of the current to the OLED element E1 connected from its drain. The transistors M1 and M6 are controlled by the emission control signal EM input to their gates from the scanning circuit 131 or 132. In this example, the scanning circuit 132 outputs the emission control signal EM to the pixel circuit rows one after another.

The transistor M7 works to supply a reset potential to the anode of the OLED element E1. When the transistor M7 is turned ON by the selection signal S1_N-1 input to its gate, it supplies the reset potential from the reset power line VRST to the anode of the OLED element E1. The selection signal S1_N-1 means the selection signal S1 to the (N-1)th pixel circuit row. The selection signal S1 is output from the scanning circuit 131 to the pixel circuit rows one after another. In this example, each selection signal S1 is output to a plurality of pixel circuit rows simultaneously.

The transistor M5 controls whether to supply the reset potential to the gate of the driving transistor M3. The source of the transistor M5 is connected to an intermediate node N4 between the transistors M4 and M8. The transistors M5 and M8 (the second switching transistor and the first switching transistor) are connected in series between the reset power line VRST and the storage capacitor Cst or the gate node N1 of the driving transistor M3. The intermediate node N4 is also an intermediate node between the transistors M5 and M8.

When the transistor M5 is turned ON by the selection signal S1_N input from the scanning circuit 131 or 132 to its gate, it supplies the reset potential from the reset power line VRST connected to its drain to the intermediate node N4. The reset potential to the anode of the OLED element E1 and the reset potential to the intermediate node N4 can be different.

The transistor M2 is a selection transistor for selecting the pixel circuit 500 to be supplied with a data signal. The gate voltage of the transistor M2 is controlled by the selection signal S2 supplied from the scanning circuit 131. As will be described later, the selection signal S2 is also a selection signal S1_N+1. When the selection transistor M2 is ON, it supplies a data signal supplied from the driver IC 134 via a data line VDATA to the gate of the driving transistor M3 (the storage capacitor Cst).

In this example, the source and the drain of the selection transistor M2 are connected between the data line VDATA and the source of the driving transistor M3. In addition, the transistors M4 and M8 are connected in series between the drain and the gate of the driving transistor M3. Either the source or the drain of the transistor M4 is connected to the drain of the transistor M3 and the other one is connected to either the source or the drain of the transistor M8. The other source or drain of the transistor M8 is connected to the gate of the transistor M3 via the gate node N1 of the transistor M3.

The transistors M4 and M8 are controlled by the selection signal S2 to work to calibrate the threshold voltage of the driving transistor M3. When the transistors M4 and M8 are ON, the driving transistor M3 is a diode-connected transistor. The data signal from the data line VDATA is supplied to the storage capacitor Cst via the channels (the sources and drains) of the selection transistor M2, the driving transistor M3, and the transistors M4 and M8, which are all ON.

The storage capacitor Cst holds the gate-source voltage of the driving transistor M3 and in the example of FIG. 2, one end is connected to the gate node N1 of the driving transistor M3 and the other end is connected to a node between the power line PVDD and the transistor M1. The storage capacitor Cst holds a data signal (voltage) adjusted depending on the threshold voltage Vth of the driving transistor M3.

The pixel circuit 500 further includes capacitors C1 and C2. One end of the capacitor C1 is connected to a power line VC having a constant potential and the other end is connected to the node N4. One end of the capacitor C2 is connected to an intermediate node between the signal line for the selection signal S2 and the gate of the transistor M8 and the other end is connected to the node N4.

The potentials of the power lines PVDD, PVEE, VRST, and VC are fixed. The potential of the power line PVDD is higher than the potential of the power line PVEE; the potential of the power line VRST is lower than the potential of the power line PVDD and is no more than or no less than the potential of the power line PVEE. The relations of the potential of the power line VC and the potentials of the other power lines have no limitations and the potential of the power line VC can be at any value. The potential of the power line VC can be equal to any one of the power lines, for example, the potential of the power line PVDD or the power line VRST. Sharing a power line makes the line layout simpler.

For example, PVDD can be at 4.6 V; PVEE can be at -2.7 V; VRST can be at -3.5 V; and VC can be at 4.6 V. Further, the H-level potentials VGH of the selection signal S1 and the emission control signal EM can be 7.0 V and their L-level potentials VGL can be -8.0 V. These values are examples and these potentials are determined depending on the design of the display device.

The transistor M8 and the capacitors C1 and C2 can reduce the leakage current that flows from the storage capacitor Cst via the transistors M8 and M4. To explain this effect, the operation of the pixel circuit 500 is described.

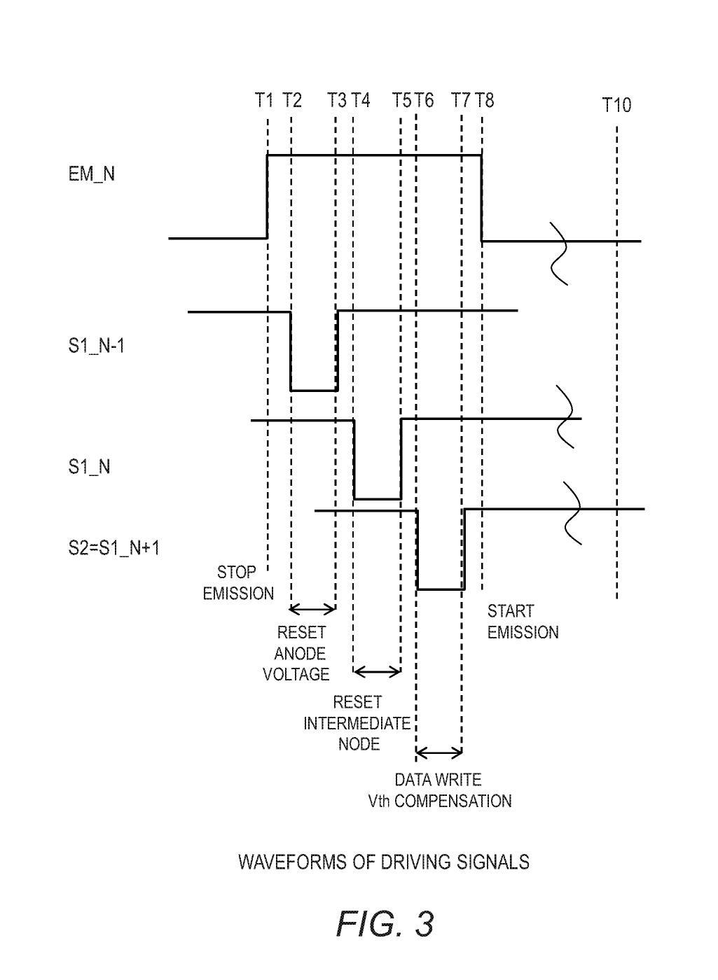

FIG. 3 is a timing chart of the signals for controlling the pixel circuit 500 illustrated in FIG. 2 in one frame period. FIG. 3 is a timing chart to select the N-th row and write a data signal from the data line VDATA to the pixel circuit 500. Specifically, FIG. 3 illustrates temporal variations in the emission control signal EM, the selection signal S1_N-1, the selection signal S1_N, and the selection signal S2. The selection signal S2 is the same as the selection signal S1_N+1.

At a time T1, the emission control signal EM changes from Low to High. In response, the transistors M1 and M6 turn OFF and the light-emitting element E1 stops emitting light at the time T1. At the time T1, the selection signals S1_N-1, S1_N, and S2 are High. Accordingly, the transistors M2, M4, M5, M7, and M8 are OFF. The transistors keep these states from the time T1 until a time T2.

At the time T2, the selection signal S1_N-1 changes from High to Low. The emission control signal EM and the selection signals S1_N and S2 are High at the time T2. In response to the change of the selection signal S1_N-1, the transistor M7 turns ON. The transistors M1, M2, M4, M5, M6, and M8 are OFF. In response to the transistor M7 turning ON, the reset potential is supplied from the reset power line VRST to the anode of the OLED element E1. The reset potential is supplied to the anode of the OLED element E1 from the time T2 until a time T3.

At the time T3, the selection signal S1_N-1 changes from Low to High. In response, the transistor M7 turns OFF. At the time T3, the emission control signal EM and the selection signals S1_N and S2 are High. All switching transistors are OFF.

At a time T4, the selection signal S1_N turns from High to Low. The emission control signal EM and the selection signals S1_N-1 and S2 are High at the time T4. In response to the change of the selection signal S1_N, the transistor M5 turns ON. The transistors M1, M2, M4, M6, M7, and M8 are OFF. In response to the transistor M5 turning ON, the potential at the node N4 changes to the potential of the reset power line VRST and the capacitor C1 is charged with charges proportional to the voltage between its terminals VC-VRST.

The reset potential is supplied to the node N4 from the time T4 until a time T5. Supplying the reset potential to the node N4 in each frame reduces the effect of the hysteresis effect. From the time T4 until the time T5, the transistors M1, M2, M4, M6, M7, and M8 are OFF.

At the time T5, the selection signal S1_N changes from Low to High. In response to the change of the selection signal S1_N, the transistor M5 turns OFF. The emission control signal EM and the selection signals S1_N-1, S1_N, and S2 are High from the time T5 until a time T6. From the time T5 until the time T6, all switching transistors are OFF.

At the time T6, the selection signal S2 changes from High to Low. The emission control signal EM and the selection signals S1_N-1 and S1_N are High at the time T6. In response to the change of the selection signal S2, the transistors M2, M4, and M8 turn ON. The transistors M1, M5, M6, and M7 are OFF. As soon as the transistor M8 turns ON, the charges stored in the capacitor C1 are transferred to the storage capacitor Cst; the potential at the node N1 is reset to the reset potential VRST or a potential close to the reset potential VRST. The potential at the node N1 at this time depends on the capacitance ratio of the capacitors C1 to Cst; the potential at the node N1 gets closer to the reset potential VRST as the value of C1/Cst is larger.

Since the transistors M4 and M8 are ON, the driving transistor M3 is diode-connected. Since the transistor M2 is ON, the data signal from the data line VDATA is written to the storage capacitor Cst via the transistors M2, M3, M4, and M8.

The voltage written to the storage capacitor Cst is a data signal compensated with respect to the threshold voltage Vth of the driving transistor M3. In the period from the time T6 to a time T7, data signal write to the pixel circuit 500 and Vth compensation are performed.

At the time T7, the selection signal S2 changes from Low to High. The emission control signal EM and the selection signals S1_N-1 and S1_N are High at the time T7. In response to the change of the selection signal S2, the transistors M2, M4, and M8 turn OFF. In other words, all transistors are OFF. From the time T7 until a time T8, the states of the control signals and the transistors are maintained.

At the time T8, the emission control signal EM changes from High to Low and the transistors M1 and M6 turn from OFF to ON. The selection signals S1_N-1, S1_N, and S2 are High; the transistors M2, M4, M5, M7, and M8 remain OFF. The driving transistor M3 controls the driving current to be supplied to the OLED element E1 based on the adjusted data signal stored in the storage capacitor Cst. This means that the OLED element E1 emits light.

In the driving signal waveforms in FIG. 3, one horizontal period (1H period) is a period from the time T2 at which the selection signal S1_N-1 changes from High to Low to the time T4 at which the selection signal S1_N changes from High to Low, for example. In similar, the period from the time T4 at which the selection signal S1_N changes from High to Low to the time T6 at which the selection signal S2 changes from High to Low is also 1H period.

In the driving signal waveforms in FIG. 3, there is a short period from the time when one signal changes until the next time when another signal changes. Examples of this period are the period from the time T1 to the time T2 and the period from the time T3 to the time T4. Because of these periods, the possibility of malfunction of the pixel circuit reduces.

Reduction in leakage current from the storage capacitor Cst through the transistors M8 and M4 because of the transistor M8 and the capacitors C1 and C2 in the above-described pixel circuit operation is described.

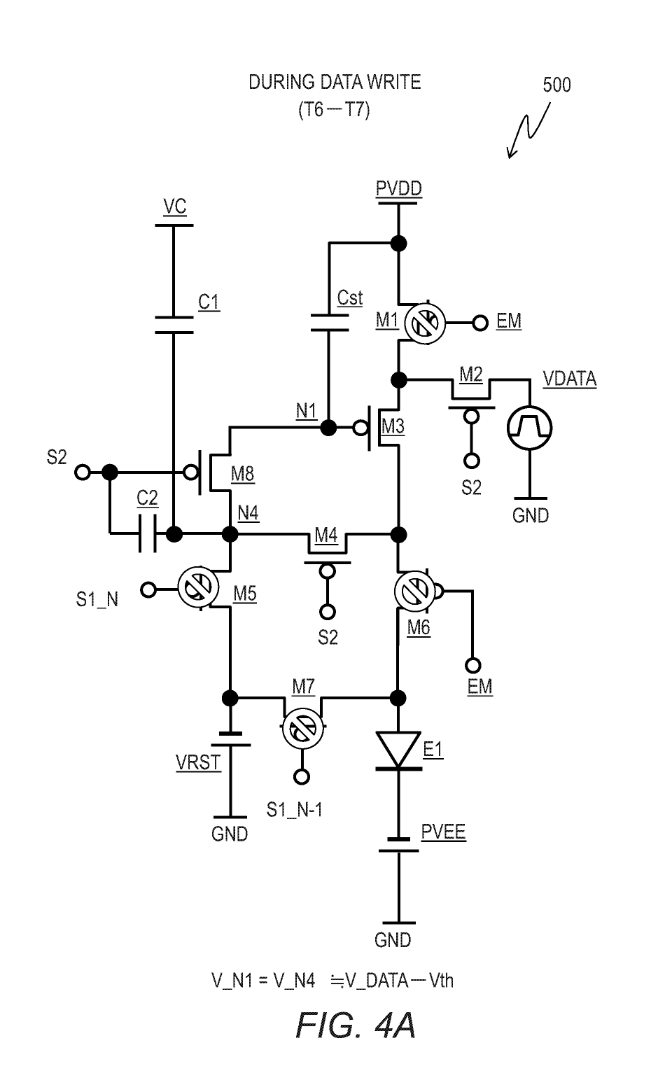

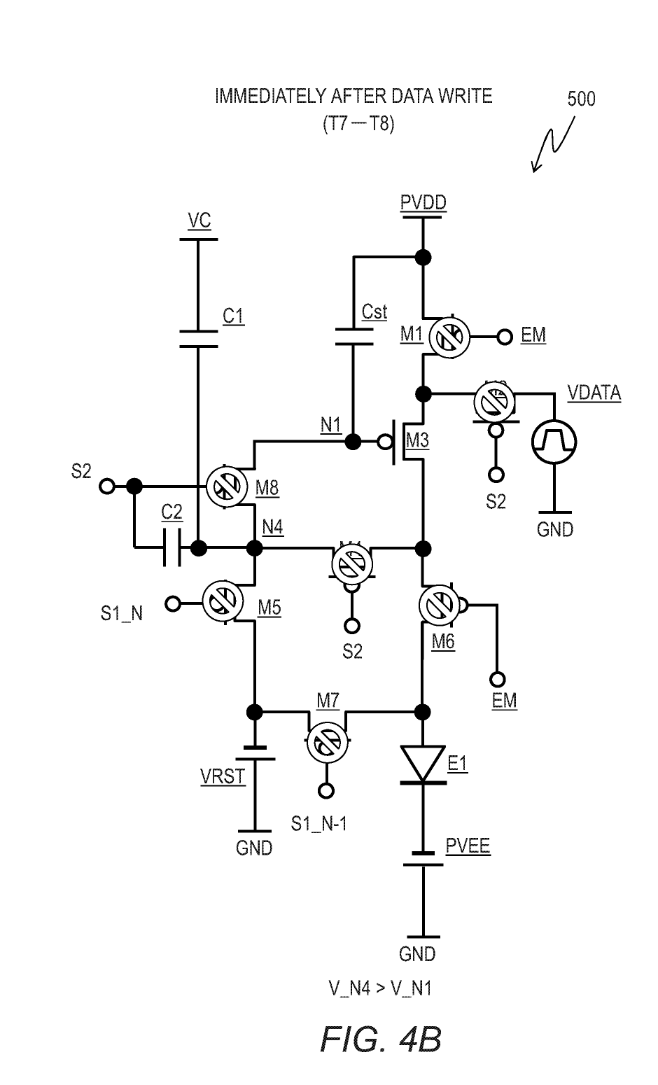

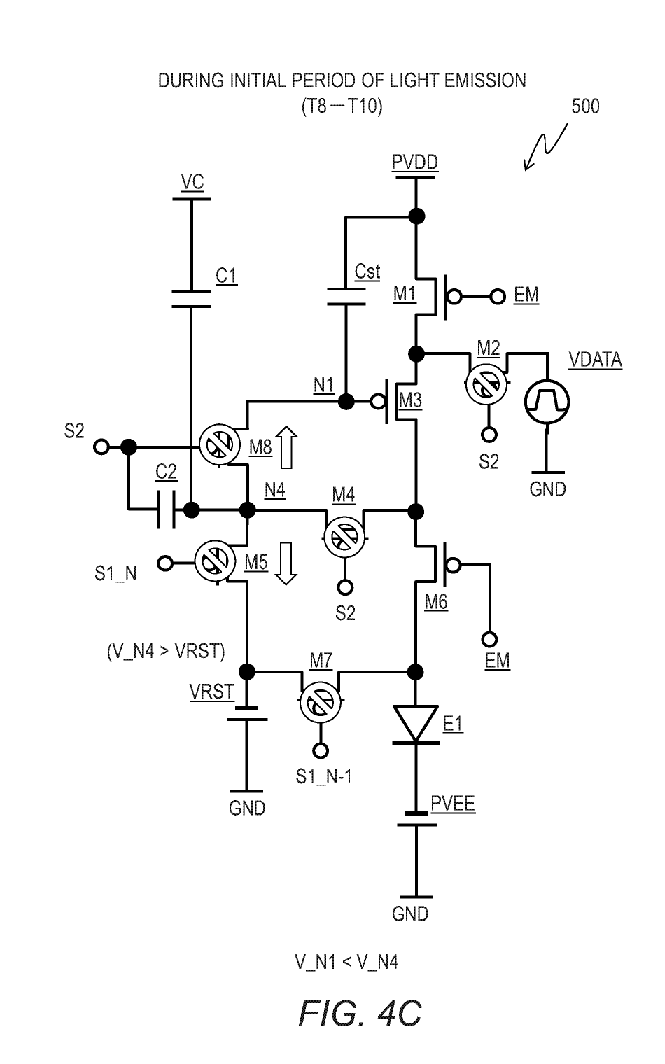

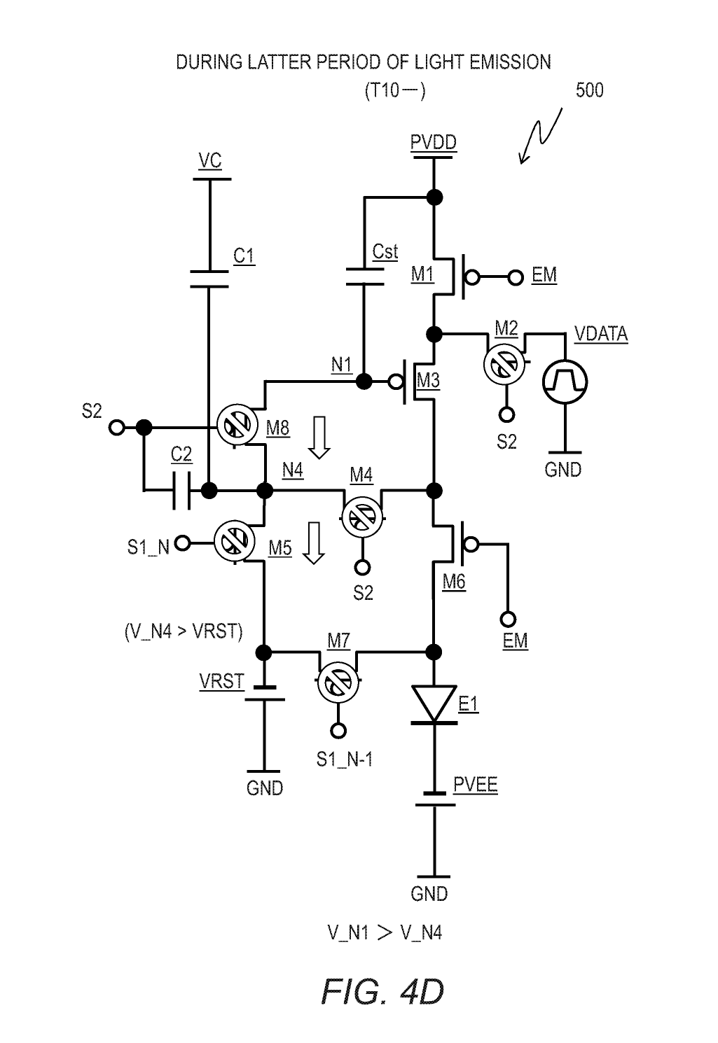

FIGS. 4A, 4B, 4C, and 4D illustrate the states of the pixel circuit 500 in the period of data write (T6 – T7), the period immediately after the data write (T7 – T8), the initial period of light emission (T8 – T10), and the latter period of light emission (T10 –), respectively.

With reference to FIG. 4A illustrating the state in the period of data write (T6 – T7), the transistors M2, M4, and M8 are ON and the transistors M1, M5, M6, and M7 are OFF. In this state, the potential at the gate node N1 of the driving transistor M3 (V_N1) is substantially equal to the potential at the intermediate node N4 between the transistors M4 and M8 (V_N4) and the voltage obtained by subtracting the threshold voltage Vth of the driving transistor M3 from the data signal (V_DATA) is almost equal to the potential at the gate node N1 (V_N1). The voltage between the source and the drain of the transistor M8 is zero and the leakage current from the transistor M8 is almost zero.

In the next period (T7 – T8) illustrated in FIG. 4B, the selection signal S2 changes from Low to High and the transistors M2, M4, and M8 turn OFF. The transistors M1, M5, M6, and M7 remain OFF. In this state, the potential V_N1 at the node N1 and the potential V_N4 at the node N4 simultaneously increase because of the feedthrough effect of the parasitic capacitors between the gate and the source and between the gate and the drain of the transistor M8. However, because of the effect of the capacitor C2, the increase in the potential V_N4 at the node N4 becomes larger than the increase in the potential V_N1, so that the potential V_N4 at the node N4 becomes higher than the potential V_N1 at the node N1 (V_N4 > V_N1).

In the initial period of light emission (T8 – T10) illustrated in FIG. 4C, the potential V_N4 at the node N4 is higher than the potential V_N1 at the node N1 and accordingly, leakage current is generated from the node N4 toward the node N1 via the transistor M8 as indicated by the upward arrow in FIG. 4C. In addition, leakage current from the node N4 toward GND via M5 is simultaneously generated as indicated by the downward arrow in FIG. 4C because the reset potential VRST is set to be lower than V_N4. Accordingly, in the initial period of light emission, V_N1 gradually rises and V_N4 gradually lowers. The capacitor C1 determines the speed of lowering the potential V_N4 at the node N4 based on the voltage held in the capacitor C1 in such a manner that the potential lowers more slowly when the capacitance is larger.

When the potential V_N4 keeps lowering, the magnitude relation between the potential V_N4 at the node N4 and the potential V_N1 at the node N1 is reversed at some time (defining as time T10) during light emission as illustrated in FIG. 4D. Accordingly, the direction of the leakage current through M8 reverses as indicated by the arrow in FIG. 4D, so that the potential V_N1 at the node N1 gradually lowers after the time T10.

Considering that the driving transistor M3 is a p-type transistor, the driving current of the driving transistor M3 in the initial period of light emission (T8 – T10) decreases with rise of the potential V_N1 at the node N1 and increases after the time T10 when the magnitude relation between the potential V_N4 at the node N4 and the potential V_N1 at the node N1 is reversed.

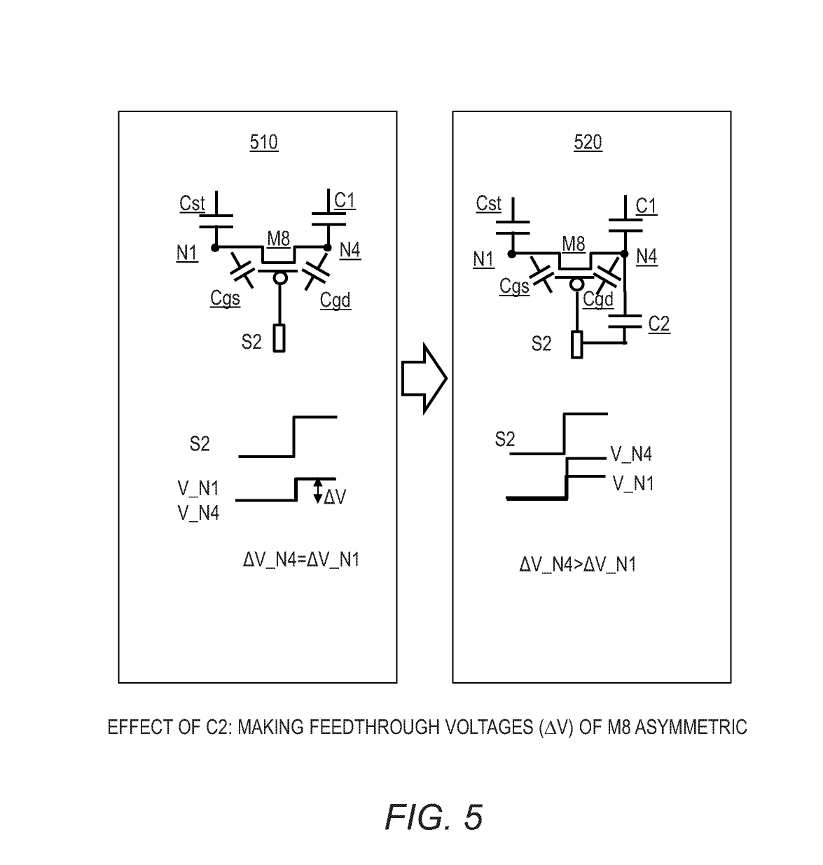

The capacitor C2 has an effect of delaying the potential drop at the node N1 by making the feedthrough voltages (ΔV) of the transistor M8 asymmetric. This effect is described with reference to FIG. 5. The section 510 illustrates a part of a pixel circuit configured by excluding the capacitor C2 from the pixel circuit 500 and the section 520 illustrates a part of the pixel circuit 500.

There exist capacitors Cgs and Cgd between the gate and the source and between the gate and the drain, respectively, of the transistor M8 and their capacitances are equal. Accordingly, change in the potential of the selection signal S2 to the gate causes a phenomenon (feedthrough) that the potentials at the nodes N1 and N4 vary because of redistribution of charges from the capacitors Cst and C1 to the parasitic capacitors Cgs and Cgd. These varied potentials are sometimes called feedthrough voltages.

As illustrated in the section 510, when the selection signal S2 changes from Low to High in the circuit without the capacitor C2, the feedthrough voltage ΔV_N1 at the node N1 and the feedthrough voltage ΔV_N4 at the node N4 are equally ΔV. Accordingly, the potential V_N1 at the node N1 and the potential V_N4 at the node N4 are equal.

On the other hand, as illustrated in the section 520, when the selection signal S2 changes from Low to High in the pixel circuit 500 including the capacitor C2, the feedthrough voltage ΔV_N4 at the node N4 is larger than the feedthrough voltage ΔV_N1 at the node N1. Accordingly, the potential V_N4 at the node N4 is higher than the potential V_N1 at the node N1.

Subsequently, the potential V_N4 at the node N4 gradually lowers because of the leakage current through the transistor M5 connected to the node N4. However, during the period where V_N4 > V_N1, the potential V_N1 at the node N1 rises. The potential V_N1 at the node N1 gradually lowers in the subsequent period where V_N4 < V_N1. Hence, the driving current from the driving transistor M3 decreases for a while and then increases.

Designing the capacitance of the capacitor C2 appropriately can reduce the amount of current variation under low-frequency driving to suppress flickers effectively. In addition, designing the average current under low-frequency driving to be equal to the average current under the driving at the frame rate in normal operation (e.g., driving at 120 Hz) enables effective reduction in flickers in switching the frequency.

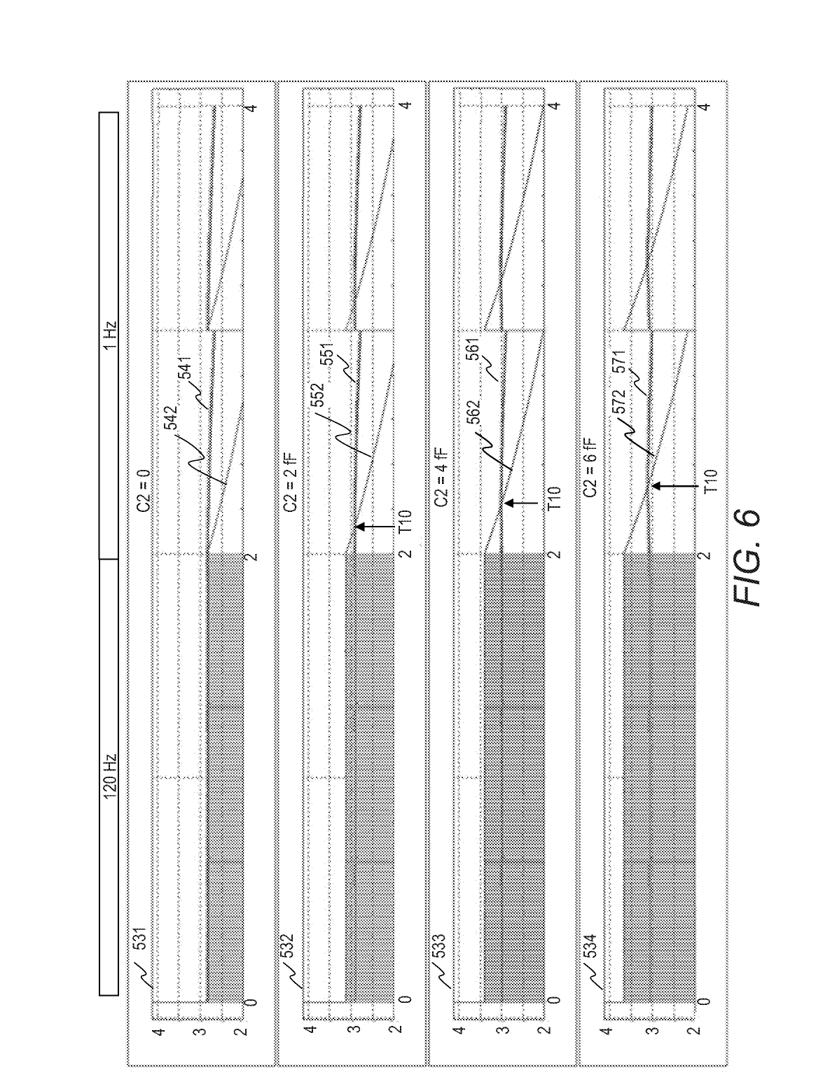

FIG. 6 provides simulation results on the temporal variation in the node potentials V_N1 and V_N4 in pixel circuits 500 each including a capacitor C2 having a different capacitance when being driven at a normal frame rate of 120Hz and a low frame rate of 1 Hz.

The graph 531 is the simulation result of a pixel circuit in which the capacitance of the capacitor C2 is 0, or a pixel circuit that does not include a capacitor C2. The graph 532 is the simulation result of a pixel circuit 500 in which the capacitance of the capacitor C2 is 2 fF. The graph 533 is the simulation result of a pixel circuit 500 in which the capacitance of the capacitor C2 is 4 fF. The graph 534 is the simulation result of a pixel circuit 500 in which the capacitance of the capacitor C2 is 6 fF. In each graph, the horizontal axis represents time (S) and the vertical axis represents voltage (V).

In the graph 531, the line 541 represents the variation in the potential V_N1 at the node N1 and the line 542 represents the variation in the potential V_N4 at the node N4. In the graph 532, the line 551 represents the variation in the potential V_N1 at the node N1 and the line 552 represents the variation in the potential V_N4 at the node N4. In the graph 533, the line 561 represents the variation in the potential V_N1 at the node N1 and the line 562 represents the variation in the potential V_N4 at the node N4. In the graph 534, the line 571 represents the variation in the potential V_N1 at the node N1 and the line 572 represents the variation in the potential V_N4 at the node N4.

In the graphs 532, 533, and 534 about the pixel circuits 500 including a capacitor C2 having a capacitance larger than 0, the potential V_N4 at the node N4 is higher than the potential V_N1 at the node N1 at the beginning of a frame and then gradually decreases to become lower than the potential V_N1 at the node N1. In the period where V_N4 > V_N1, the potential V_N1 at the node N1 increases and in the subsequent period where V_N4 < V_N1, the potential V_N1 at the node N1 gradually decreases.

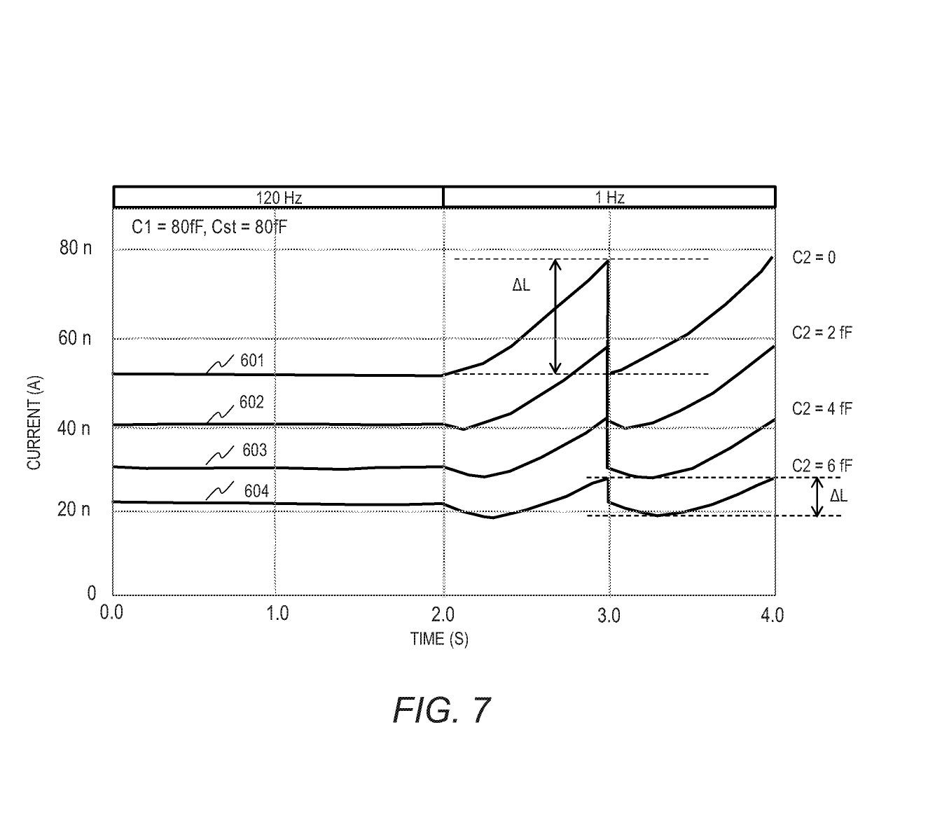

FIG. 7 provides simulation results on the temporal variation in lighting current (driving current) for the light-emitting element E1 in pixel circuits 500 each including a capacitor C2 having a different capacitance when being driven at a normal frame rate of 120Hz and a low frame rate of 1 Hz. In the graph, the horizontal axis represents time and the vertical axis represents lighting current. The data voltage in the simulation is fixed.

The curve 601 is the simulation result of a pixel circuit in which the capacitance of the capacitor C2 is 0, or a pixel circuit that does not include a capacitor C2. The curve 602 is the simulation result of a pixel circuit 500 in which the capacitance of the capacitor C2 is 2 fF. The curve 603 is the simulation result of a pixel circuit 500 in which the capacitance of the capacitor C2 is 4 fF. The curve 604 is the simulation result of a pixel circuit 500 in which the capacitance of the capacitor C2 is 6 fF.

As indicated by the simulation results in FIG. 7, adding the capacitor C2 effectively reduces the variation range ΔL of the lighting current under the low frame rate driving.

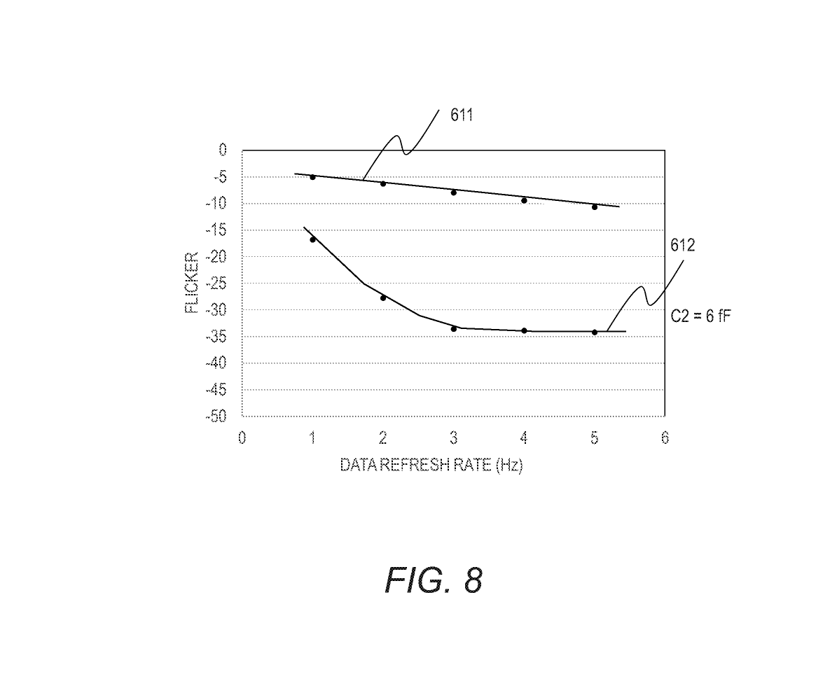

FIG. 8 provides simulation results on the relation between data refresh rate (frame rate) and a flicker in the pixel circuit 500. The horizontal axis represents data refresh rate and the vertical axis represents a flicker. The unit of the flicker is decibel. In the graph of FIG. 8, the curve 611 is the simulation result of a conventionally employed 7T1C pixel circuit (where the capacitances of the capacitors C1 and C2 are 0, or the capacitors C1 and C2 are not included). The curve 612 is the simulation result of the pixel circuit 500 including a capacitor C2 having a capacitance of 6 fF. As indicated in FIG. 8, the pixel circuit 500 in this embodiment effectively reduces the flickers under the low frame rate driving.

As described above, the average current in an overall emission period can be made almost equal to the one in the ideal case that is not affected by leakage current by designing the capacitances for the capacitors C1 and C2 appropriately for the given frame rate (data refresh rate). As a result, the flickers can be reduced more effectively.

In an embodiment of this disclosure, the capacitance of the capacitor C2 for making the feedthrough voltages asymmetric is smaller than the capacitance of the capacitor C1 for holding the voltage. This configuration effectively reduces the leakage current in the limited pixel circuit area. In an embodiment of this disclosure, the capacitance of the capacitor C1 is equal to or smaller than the capacitance of the storage capacitor Cst. This configuration achieves effective data voltage hold and leakage current suppression in the limited pixel circuit area. The capacitance of the capacitor C1 can be a half or more of the capacitance of the storage capacitor Cst. Note that the magnitude relation among the capacitances of the storage capacitor Cst and the capacitors C1 and C2 is not limited to the foregoing example.

As described above, the potential of the power line VC connected to the capacitor C1 can be determined desirably; for example, it can be the anode power-supply potential, the reset power-supply potential, or the cathode power-supply potential. Otherwise, it can be another power-supply potential such as the system ground.

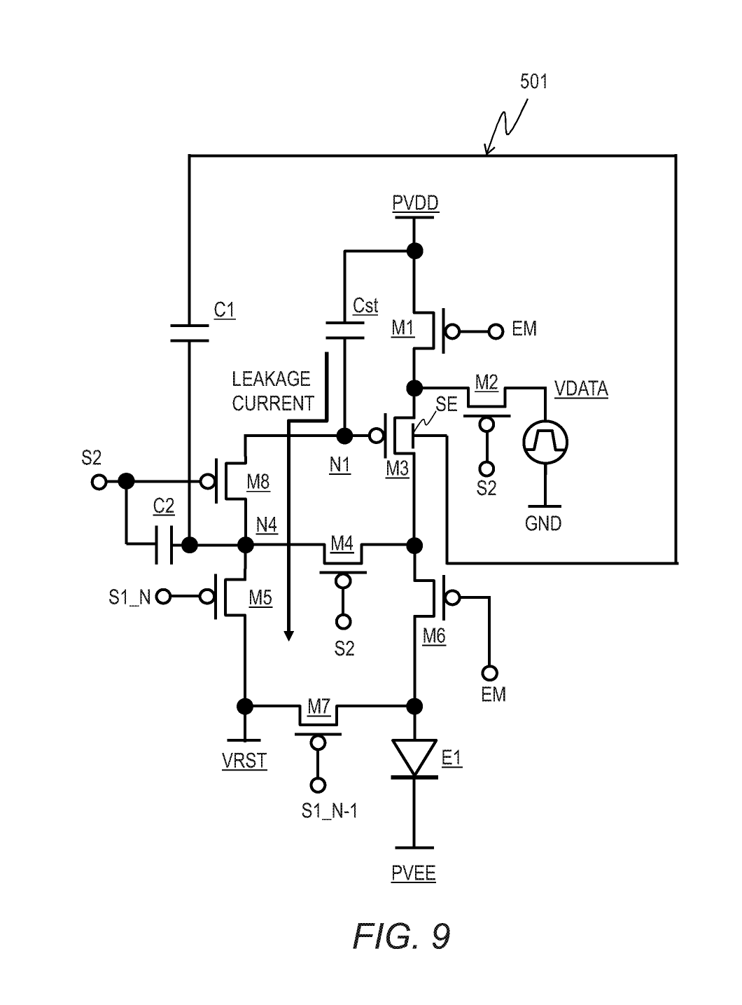

In another embodiment of this disclosure, the capacitor C1 is supplied with the same potential as the shield electrode of the driving transistor M3. FIG. 9 illustrates a pixel circuit 501 in which an end of the capacitor C1 is connected to the shield electrode SE of the driving transistor M3. Compared to the pixel circuit 500 in FIG. 2, one end of the capacitor C1 is connected to the shield electrode SE, instead of the power line VC. The other configuration of the pixel circuit 501 is the same as the pixel circuit 500.

The shield electrode is disposed between the channel of the transistor M3 and the substrate and supplied with a constant potential, such as the system ground. However, the potential for the shield electrode is selected desirably. Since the metal layer for the shield electrode is located lower than the transistors M1 to M8, device designing for the pixel circuit is facilitated.

The electrode of the capacitor C1 to be supplied with a constant potential is included in the layer including the power line therefor. The electrode of the capacitor C1 to be supplied with the constant potential (power-supply potential) and the power line therefor or the shield electrode can be included in an unseparated conductor film. For example, the electrode of the capacitor C1, the anode power line PVDD, the reset power line VRST, the cathode power line PVCC, or the shield electrode SE can be included in a unseparated conductor film. Electrically connecting the electrode to a power line not via a contact region achieves a smaller circuit area and facilitates the circuit device designing.

### Device Structures

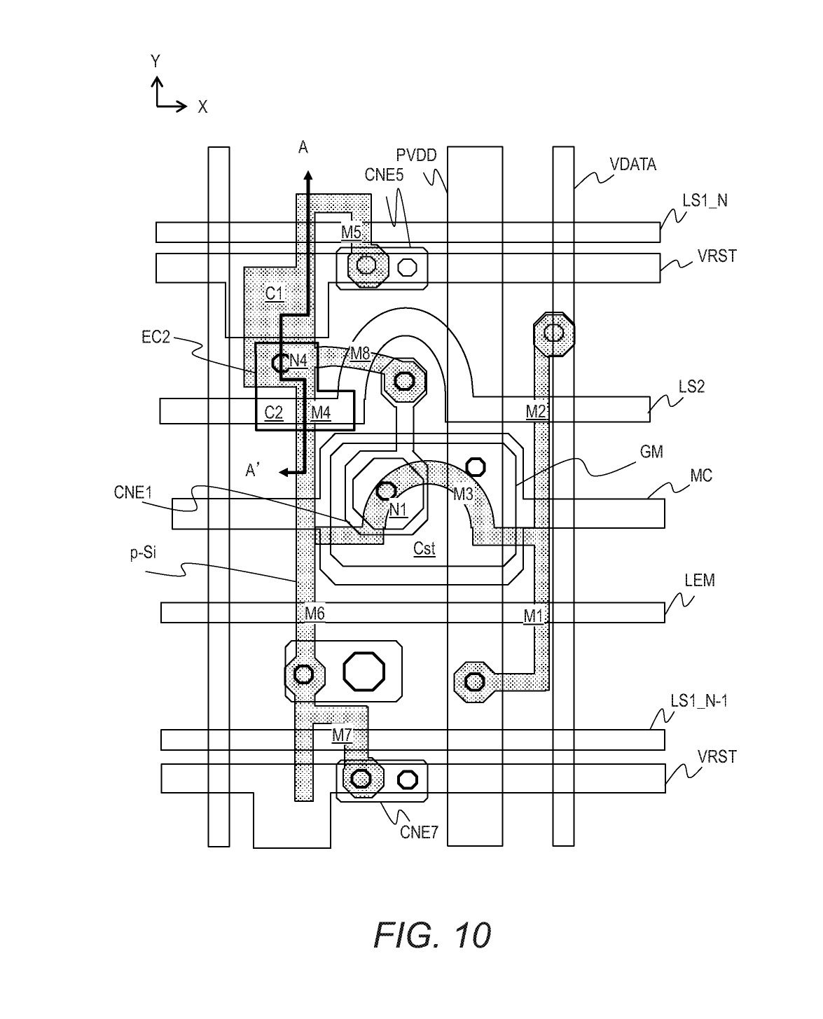

Hereinafter, examples of the device structure of a pixel circuit are described. FIG. 10 is a plan diagram schematically illustrating an example of the device structure of a pixel circuit viewed along the layering direction (in a top view). With respect to FIG. 10 and other plan diagrams of pixel circuits to be described in the following, the pixel circuits constituting a display region other than the pixel circuit illustrated in a diagram have the same structure as the one illustrated in the diagram.

In the pixel circuit in FIG. 10, the capacitor C1 is configured between the reset power line VRST and a region of a polysilicon layer corresponding to the node N4. The capacitor C2 is configured between the transmission line LS2 for the selection signal S2 and an island-like capacitor electrode EC2. Specifically, a part of the transmission line LS2 and a part of the capacitor electrode EC2 are opposed across an insulating layer (a single layer or multilayer) to configure the capacitor C2.

FIG. 10 shows a polysilicon layer and conductor layers in a pixel circuit. The octagons represent contact regions between regions of different conductor layers. A contact region is a conductor region provided in a hole extending in the layering direction through an insulating layer.

The transmission lines LS1_N, LS2, LS1_N-1, and LEM transmit the selection signals S1_N, S2, and S1_N-1 and the emission control signal EM, respectively. These are included in the first metal layer and formed simultaneously. The first metal layer is a conductor layer. In the example of FIG. 10, these lines extend in the x-axis direction. The selection signal S1_N is in common with the selection signal S2 for the previous row.

As described with reference to FIG. 2, the pixel circuit includes transistors M1 to M8. The channels of the transistors are included in the polysilicon layer p-Si. In FIG. 10, the polysilicon layer p-Si is indicated by the same dot pattern and it is located lower than the other conductor layers. Some regions of the polysilicon layer p-Si, including channel regions, are a semiconductor (highly resistive) and the other regions are a conductor (low resistive). The gate electrodes of the transistors M1 to M8 are included in the first metal layer.

A part of a conductor region MC covers the entire gate electrode of the driving transistor M3. The conductor region MC is connected to the anode power line PVDD via a contact hole. The conductor region MC is located upper than the first metal layer. The part of the conductor region MC works as an electrode of the storage capacitor Cst. The conductor region MC extends in the x-axis direction and has the same shape in the adjacent pixels. The anode power line PVDD and the data signal line VDATA extend in the y-axis direction. These lines are included in the second metal layer located upper than the conductor region MC.

FIG. 10 includes two reset power lines VRST extending in the x-axis direction. The conductor region MC and the reset power lines VRST are included in the same intermediate conductor layer and formed simultaneously. A part of the reset power line VRST is opposed to a part of the polysilicon layer p-Si across an insulating region to configure the capacitor C1.

The capacitor electrode EC2 and the connector electrodes CNE1, CNE5, and CNE7 are included in the second metal layer. A part of the capacitor electrode EC2 is opposed to a part of the transmission line LS2 across an insulating region to configure the capacitor C2. The connector electrode CNE1 connects the transistor M8 and the node N1 (the gate electrode of the driving transistor M3) via contact regions extending through an insulating region. The connector electrodes CNE5 and CNE7 connect the transistors M5 and M7, respectively, to the reset power line VRST via contact regions each extending through an insulating region.

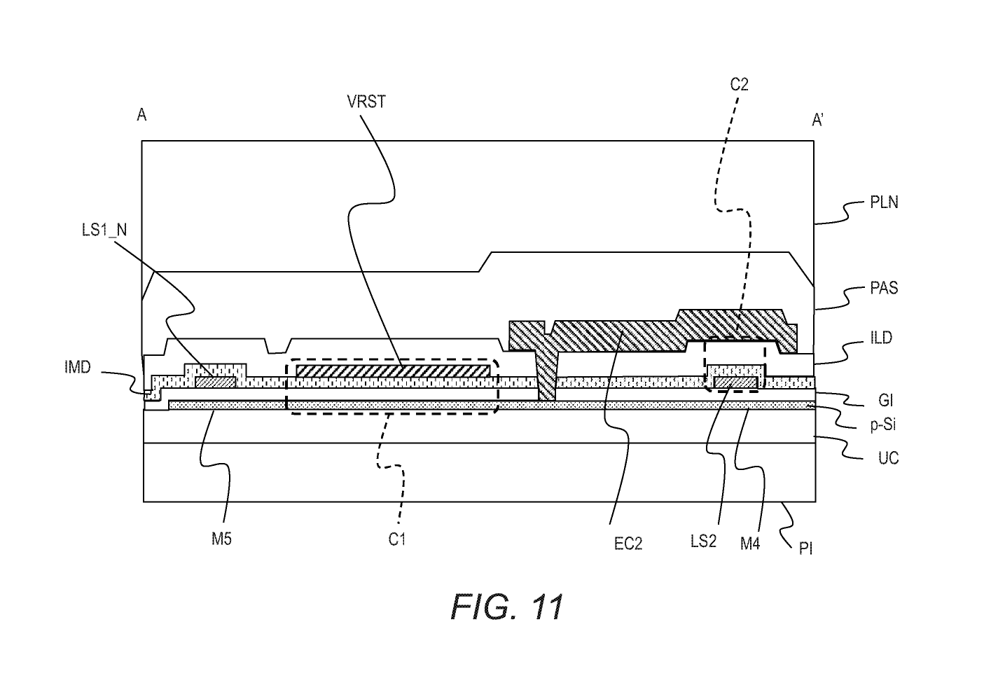

FIG. 11 schematically illustrates the cross-sectional structure along the section line A-A’ in FIG. 10. FIG. 11 mainly illustrates the transistors M5 and M4 and the capacitors C1 and C2. The layered structure of the pixel circuit is formed on a polyimide layer PI. The polyimide layer PI can be a substrate or a layer above a not-shown substrate. In addition, another layer such as an organic insulating layer or an inorganic insulating layer can be provided between the polyimide layer PI and the substrate (e.g., a glass substrate).

An undercoat layer UC (e.g., a silicon nitride layer) is provided above the polyimide layer PI. A polysilicon layer p-Si is laid above the undercoat layer UC. Further, a gate insulating layer GI is laid to cover the polysilicon layer p-Si. The gate insulating layer GI can be made of silicon oxide or silicon nitride.

The first metal layer is laid above the gate insulating layer GI. Specifically, the transmission line LS1_N and LS2 for transmitting the selection signals S1_N and S2, respectively, are shown in FIG. 11. In FIG. 11, the transmission line LS1_N corresponds to the gate electrode of the transistor M5 and the transmission line LS2 corresponds to the gate electrode of the transistor M4. The first metal layer can be made of a metal having a high melting point, such as W, Mo, or Ta or an alloy of such a metal.

An interlayer insulating layer IMD is laid to cover the first metal layer. The interlayer insulating layer IMD can be made of silicon oxide or silicon nitride. The intermediate conductor layer is laid above the interlayer insulating layer IMD. The intermediate conductor layer can have a single layer structure of a metal having a high melting point, such as W, Mo, or Ta, an alloy of such a metal, or Al, or a multilayered structure of Ti/Al/Ti.

Specifically for the intermediate conductor layer, a reset power line VRST is shown in FIG. 11 and a part of it corresponds to an electrode of the capacitor C1. The region (low-resistive region) of the polysilicon layer p-Si opposed to the reset power line VRST corresponds to the other electrode of the capacitor C1 and connects the source/drain regions of the transistors M4 and M5. The insulating layer of the capacitor C1 has a layered structure of the gate insulating layer GI and the interlayer insulating layer IMD.

An interlayer insulating layer ILD is laid to cover the intermediate conductor layer. The interlayer insulating layer ILD can be made of silicon oxide or silicon nitride. The second metal layer is provided above the interlayer insulating layer ILD. FIG. 11 shows a capacitor electrode EC2 included in the second metal layer. A part of the capacitor electrode EC2 is opposed to the transmission line LS2 across the gate insulating layer GI and the interlayer insulating layer IMD. The capacitor electrode EC2 is connected to the polysilicon layer P-Si through a hole opened through the interlayer insulating layer ILD and the gate insulating layer GI. In this example, the capacitor electrode EC2 is in direct contact with the polysilicon layer P-Si.

A passivation layer PAS and a planarization layer PLN above the passivation layer PAS are provided to cover the layers lower than them. These layers can be made of an organic or inorganic insulator.

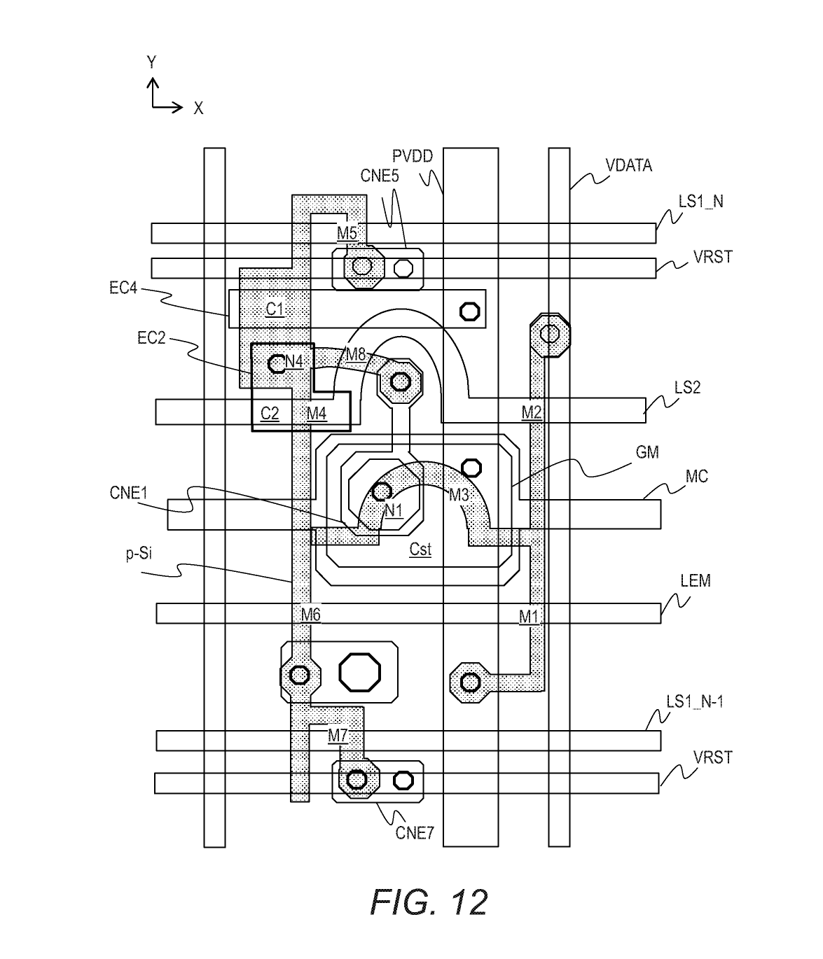

FIG. 12 is a plan diagram schematically illustrating another example of the device structure of a pixel circuit viewed along the layering direction (in a top view). In this pixel circuit, the capacitor C1 is configured between the anode power line PVDD and the region of the polysilicon layer forming a node N4. Compared to the configuration example in FIG. 10, a part (wide region) of the reset power line VRST corresponding to an electrode of the capacitor C1 is excluded and a capacitor electrode EC4 is added. The remaining, including the configuration of the capacitor C2, is substantially the same as the configuration illustrated in FIG. 10.

The pixel circuit in FIG. 12 includes a capacitor electrode EC4. The capacitor electrode EC4 can be included in the intermediate conductor layer together with the reset power line VRST. The capacitor electrode EC4 and the polysilicon layer p-Si are opposed across an insulating layer to configure the capacitor C1. The insulating layer can have a layered structure consisting of the gate insulating layer GI and the interlayer insulating layer IMD shown in FIG. 11. In the example in FIG. 12, a part of the capacitor electrode EC4 and a part of the polysilicon layer p-Si are opposed in the layering direction. The anode power line PVDD provided upper than them is connected to the capacitor electrode EC4 via a contact region in a hole extending through the interlayer insulating layer ILD shown in FIG. 11.

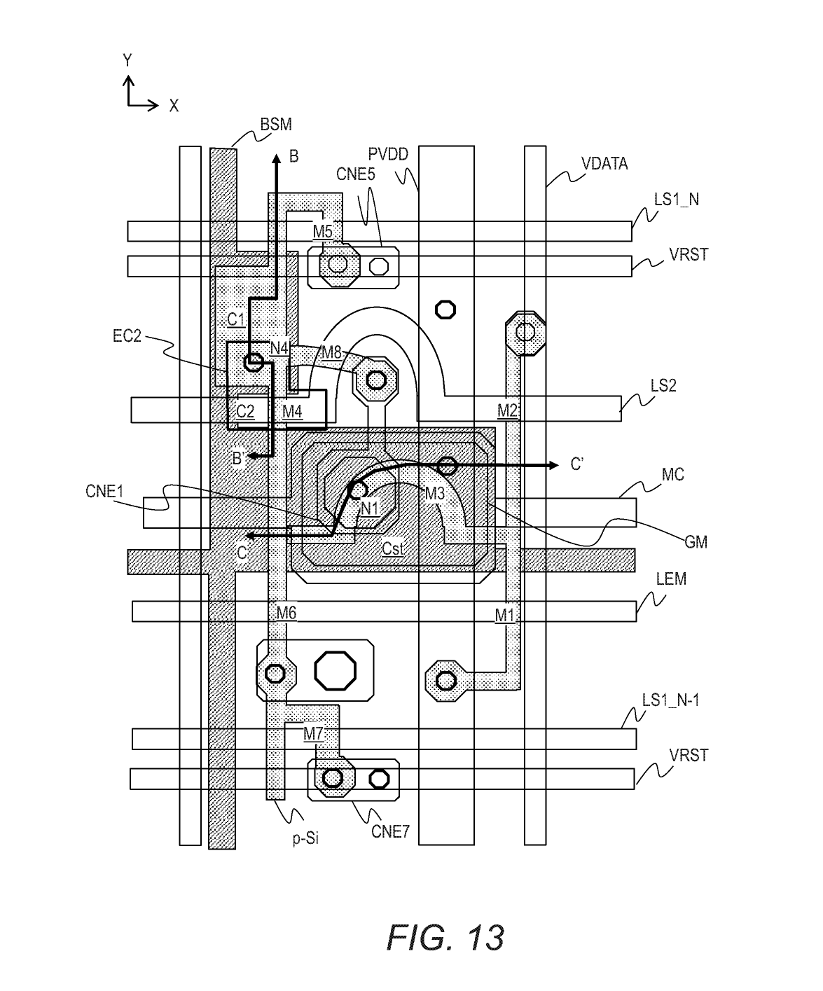

FIG. 13 is a plan diagram schematically illustrating still another example of the device structure of a pixel circuit viewed along the layering direction (in a top view). This pixel circuit includes a BSM layer made of a conductor lower than the polysilicon layer p-Si and the capacitor C1 is configured between the BSM layer and the polysilicon layer p-Si.

Since the node N4 is made of the polysilicon layer p-Si, configuring the capacitor C1 between the node N4 and the BSM layer thereunder attains a relatively large capacitance with a smaller circuit area. Compared to the configuration example in FIG. 12, the capacitor electrode EC4 is excluded and the BSM layer is added. The remaining, including the configuration of the capacitor C2, is substantially the same as the configuration example in FIG. 12.

The BSM layer is continued to the same constituent element in the adjacent pixel circuits, like the power lines PVDD and VRST and the transmission lines LS1_N-1, LS1_N, LS2, LEM, and VDATA.

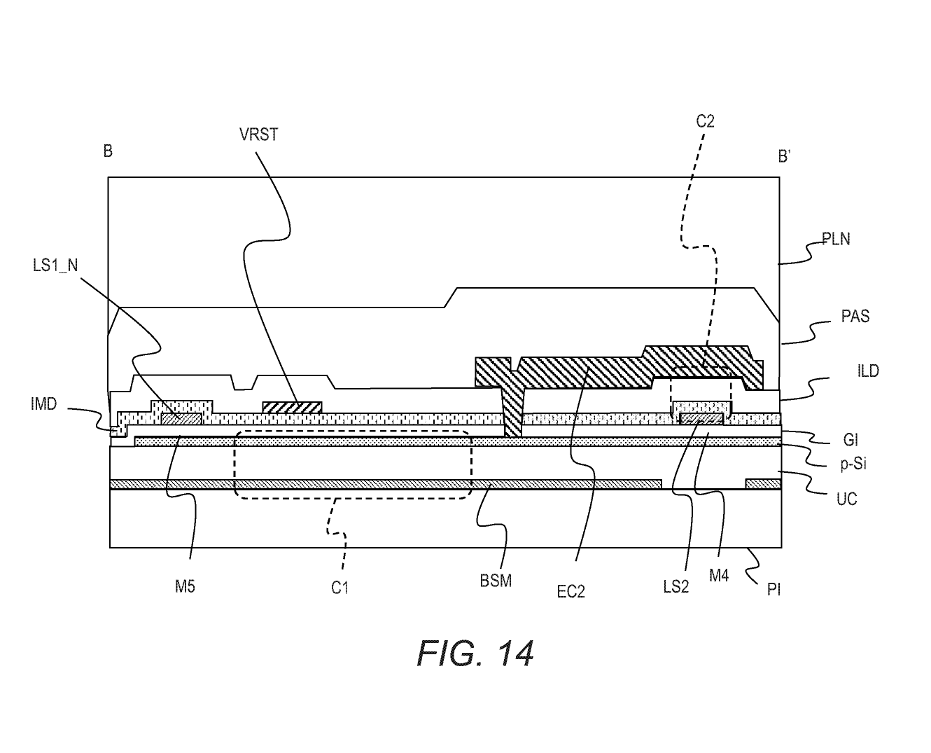

FIG. 14 schematically illustrates the cross-sectional structure along the section line B-B’ in FIG. 13. FIG. 14 mainly illustrates the transistors M5 and M4 and the capacitors C1 and C2. The BSM layer is located between the polyimide layer PI and the undercoat layer UC. The BSM layer can be made of a metal. For example, it can be made a metal having a high melting point, such as W, Mo, or Ta or an alloy of such a metal.

The capacitor C1 is configured between the BSM layer and the polysilicon layer p-Si. More specifically, a part of the BSM layer and a part of the polysilicon layer p-Si are opposed across the undercoat layer UC to configure the capacitor C1. The capacitor C1 configured between the polysilicon layer p-Si and the BSM layer thereunder facilitates designing a capacitor having a larger area and capacitance. The undercoat layer UC can have a layered structure.

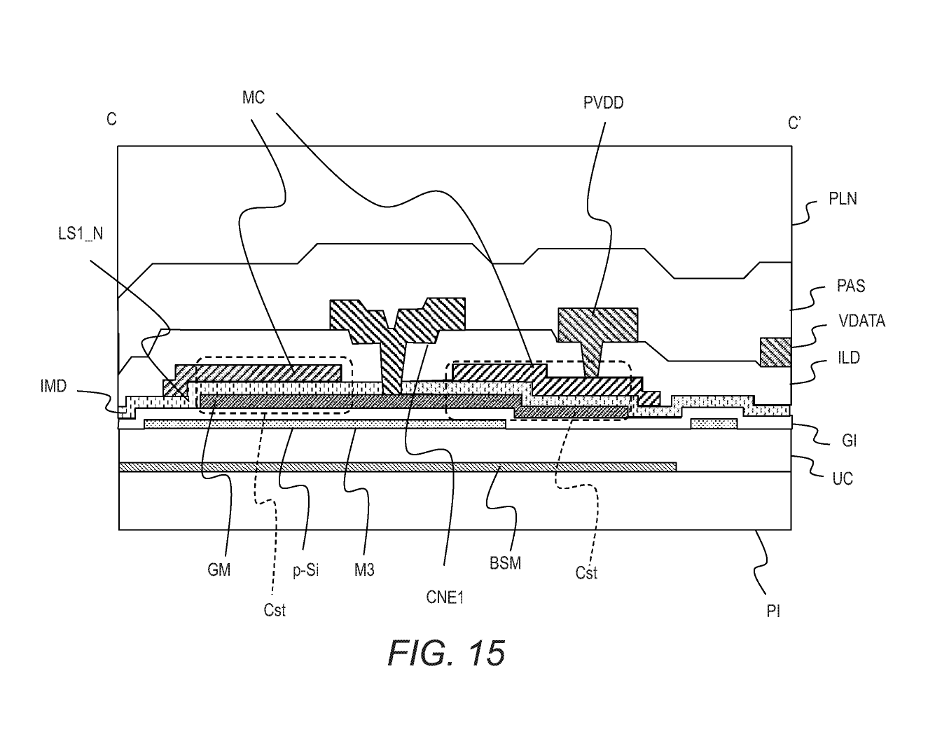

FIG. 15 schematically illustrates the cross-sectional structure along the section line C-C’ in FIG. 13. FIG. 15 illustrates the cross-sectional structure of the driving transistor M3 and its periphery. The gate electrode of the driving transistor M3, which is a part of the gate metal layer GM, covers the channel of the polysilicon layer p-Si with the gate insulating layer GI interposed therebetween to control the amount of current flowing through the channel. The conductor region MC is laid above the gate metal layer GM across the interlayer insulating layer IMD and their opposed regions configure the storage capacitor Cst.

The conductor region MC is connected to the anode power line PVDD via a hole in the interlayer insulating layer ILD. In this example, the anode power line PVDD is in direct contact with the conductor region MC. The conductor region MC has an opening; the connector electrode CNE1 is connected to the gate metal layer GM via the opening and a hole in the interlayer insulating layer IMD. In this example, the connector electrode CNE1 is in direct contact with the gate metal layer GM.

As illustrated in FIGS. 13 and 15, the BSM layer covers a region including the channel of the driving transistor M3 when viewed from the polyimide layer PI (lower side). The BSM layer is supplied with a constant potential, for example, the system ground, to shield the driving transistor M3 from the fixed charge in the polyimide layer PI that affects the operation of the driving transistor M3.

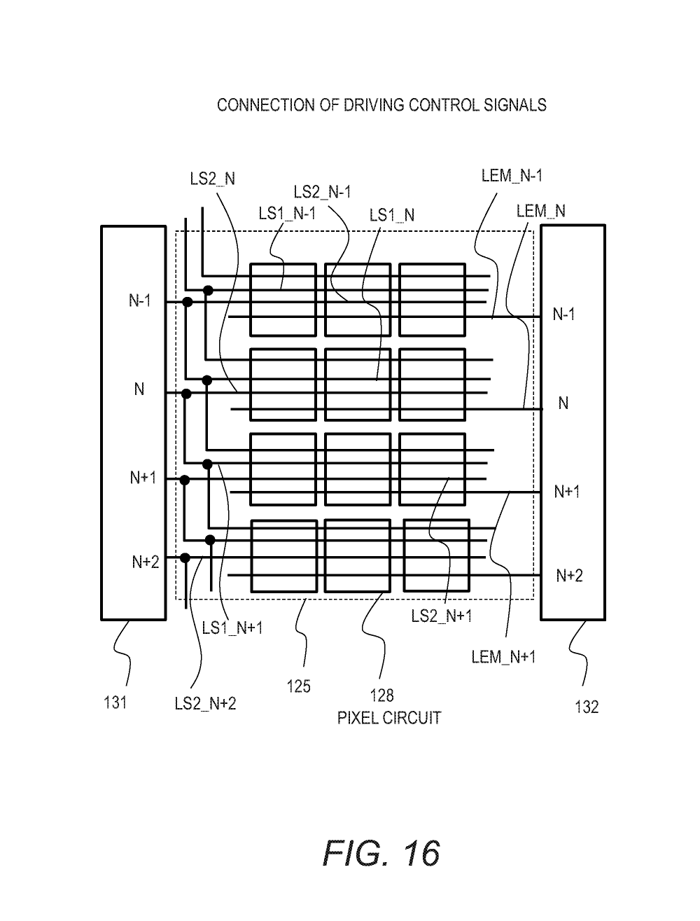

FIG. 16 illustrates an example of the relation between transmission lines for the driving control signals, namely, the transmission lines for the selection signals S1 and S2 and the emission control signal EM, and the scanning circuits 131 and 132. The scanning circuit 131 is a driver circuit for the selection signals S1 and S2 and the scanning circuit 132 is a driver circuit for the emission control signal EM. Each of the scanning circuits 131 and 132 outputs a signal from its output terminals one after another.

The display region 125 includes pixel circuits 128 arrayed in a matrix. The transmission lines LS1_N-1, LS1_N, LS2_N, and LEM_N transmit the driving control signals for the N-th pixel circuit row. Specifically, the transmission lines LS1_N-1, LS1_N, LS2_N, and LEM_N supplies the selection signal S1_N-1, the selection signal S1_N, the selection signal S2, and the emission control signal EM, respectively, to the N-th pixel circuit row. The transmission lines LEM_N-1 and LEM_N+1 are transmission lines for the emission control signals for the (N-1)th pixel circuit row and the (N+1)th pixel circuit row, respectively.

Each terminal of the scanning circuit 131 outputs a signal to three transmission lines. Specifically, the N-th terminal outputs a signal to the transmission line LS2_N for the N-th pixel circuit row, the transmission line LS1_N+1 for the (N+1)th pixel circuit row, and the transmission line LS1_N+2 for the (N+2)th pixel circuit row. As noted from this example, supplying the same signal to three consecutive pixel rows enables simplification of the scanning circuit 131, although three signals may be output from terminals of different scanning circuits.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A pixel circuit comprising:
a light-emitting element;
a driving transistor configured to control electric current to be supplied to the light-emitting element;
a storage capacitor connected to a gate node of the driving transistor;
a first switching transistor and a second switching transistor connected in series between the gate node of the driving transistor and a constant potential supply line;
a first capacitor connected between a constant-potential node and an intermediate node between the first switching transistor and the second switching transistor; and
a second capacitor connected between the intermediate node and a gate node of the first switching transistor.

2. The pixel circuit according to claim 1, wherein the second capacitor has a smaller capacitance than the first capacitor.

3. The pixel circuit according to claim 2, wherein the first capacitor has a capacitance equal to or smaller than a capacitance of the storage capacitor.

4. The pixel circuit according to claim 1, further comprising:
a shielding conductor layer including a region between a channel of the driving transistor and a substrate, the shielding conductor layer being configured to be supplied with a constant potential,
wherein one electrode of the first capacitor is included in the shielding conductor layer.

5. The pixel circuit according to claim 1, further comprising:
a third switching transistor connected between a drain of the driving transistor and the intermediate node,
wherein the second switching transistor is configured to be controlled by a first selection signal,
wherein the first switching transistor and the third switching transistor are configured to be controlled by a second selection signal, and
wherein the first switching transistor and the third switching transistor are turned on and subsequently turned off after the second switching transistor is turned on and subsequently turned off.
